(19) United States
(12) Patent Application Publication
(10) Pub. No.: US 2005/0027726 A1
(43) Pub. Date: Feb. 3, 2005

(54) System for controlling quality and traceability of products

(76) Inventors: Lionel Guivarch, Rennes (FR); Baptiste Guivarch, Aeigre (FR); Vincent Texier, Rennes (FR); Yves-Marie Roth, Gregoire (FR); Nicolas Gestraud, Rennes (FR)

Correspondence Address: Darin Bartholomew;Deere & Company, 3rd Flr. 2 North, One John Deere Place, Moline, IL, 61265, US

(21) Appl. No.: 10/922,318

(22) Filed: Aug. 19, 2004

(30) Foreign Application Priority Data
Feb. 19, 2003 (WO) PCT/FR03/00553
Feb. 20, 2002 (FR) FR 02/02153

(51) Int. Cl. G06F 17/00

(52) U.S. Cl. 707/100

(57) ABSTRACT

A service platform comprises: (a) a traceability database intended to receive, from computer apparatus of each actor in the logistics chain, an identifier of an operation carried out, an identifier of the operator, information concerning the date the operation was carried out, and an identifier of the operation carried out immediately upstream of or downstream of the given actor; (b) a database, recording (in memory) the rights of access of each actor, to information stored in the respective databases of the other actors; and (c) a routing database, providing the information needed for routing of the information between the actors, depending on data furnished by the traceability database and depending on the right-of-access database.

This application claims priority based on the application, designated International Publication Number PCT/FR03/00553, filed Feb. 19, 2003, under 35 U.S.C. 120, which in turn claims priority based on French patent application no. FR 02/02153, filed Feb. 20, 2002.

### FIELD OF THE INVENTION

The invention relates to a method, a system, and a platform, for ensuring the quality of products manufactured or processed by a plurality of interveners.

### BACKGROUND OF THE INVENTION

Food safety is a major concern of public authorities and consumers. For this reason, substantial effort has been expended recently to facilitate the traceability of foods in a logistics chain. This endeavor has been both regulatory and technical. In particular, French Patent Application No. 00-11439, filed Sep. 7, 2000, proposes means for facilitating traceability with the aid of a plurality of databases connecting:

(a) the various actors in the logistics chain for foodstuffs,

(b) professional organizations, and

(c) consumers.

### SUMMARY OF THE INVENTION

According to one aspect of the invention, which may be utilized independently of the other aspects described herein, the invention relates to a service platform for supporting communications (e.g., via the Internet) between or among computer devices of actors, in a logistics chain for manufacturing or processing of products (e.g., food products).

This service platform comprises:

(a) a traceability database for receiving, from at least one of a local traceability databases and computer apparatus of each actor in the logistics chain, an operation identifier of an operation carried out, an operator identifier of the operator, date information concerning the date the operation was carried out, and a context identifier of the operation carried out immediately upstream of or downstream of the given actor;

(b) a relationship database for recording the rights of access of each actor, to information stored in the respective local databases of the other actors; and

(c) a routing database, providing the information needed for routing of the information between the actors, depending on data furnished by the traceability database and depending on the right-of-access database.

Thus, the invention offers a highly simple architecture for establishing relationships between various actors in a logistics chain. This architecture, despite its simplicity, enables one to easily achieve traceability, while preserving the confidentiality of each actor's information.

### BRIEF DESCRIPTION OF THE DRAWINGS

Other characteristics and advantages of the invention will be apparent from the description of certain embodiments of the invention, with reference to the accompanying drawings.

FIG. 1 is a schematic depiction of the physical architecture of a platform according to the invention; and

FIG. 2 is a schematic of creation of, and of linking between, documents modeled according to the invention.

### DESCRIPTION OF THE PREFERRED EMBODIMENT

As used herein, the terms “operation” and “process” have been used essentially synonymously. Further, “date” may mean “date and time” under appropriate circumstances or as the context requires hereunder.

The system described in the present patent application offers a convenient means of accessing information relating to a specific food product, according to rights granted to each actor, organization, or consumer.

The traceability allows rapid alerting of interveners and consumers in the event of an incident (e.g., contamination or quality problem) with a product. Thus, according to a first aspect of the invention, it is an object of the invention to provide means of more readily identifying the origin of an incident.

According to another aspect of the invention, it is an object of the invention to facilitate the meeting of requirements for quality, particularly those arising from consumers.

One aspect of the invention is based on the fact that quality requirements are generally reflected in a set of conditions or specifications which fixes the rules or constraints for the production and processing of food products (or other products). Stated differently, the quality of a product is expressed in terms of the production conditions and the quality of materials (products). As an example, one might cite the conditions and specifications imposed by franchisers, or conditions and specifications governing the rights of use of certain labels or certifications.

Such a set of conditions and specifications indicates, on the part of the person or organization who/which creates it and/or promotes it and/or benefits from it, a commitment to adhere to the rules or constraints, which commitment creates an obligation to clients, consumers, or public authorities.

To facilitate adherence to a set of conditions and specifications, and thus to facilitate the application of rules or constraints, and thereby to ensure, with greater certainty than has been achieved heretofore, that the products manufactured or processed satisfy quality requirements, the invention proposes a server, or a platform, comprised of means of establishing connections (relationships) between:

(a) issuers of sets of specifications in the form of parameters of products and/or parameters of their manner of production and/or parameters of their processing, and

(b) operators.

The parameters furnished by the operators can thus be compared automatically by the issuers to parameters in the corresponding set of specifications. Further, this verification can be performed in a confidential fashion, because the server according to the invention does not comprise a centralized database, but a means of routing for selective communication between the various actors. The link data stored in memory in a centralized fashion support links between the actors, particularly links between the issuers of the sets of specifications and the operators.

Suppose, e.g., a baker creates a set of specifications wherein he requires that the bread has a protein content between 14.5 and 15.5 percent by weight or volume, and that the wheat used for producing the bread is of a certain variety (e.g., the Soissons variety). The set of specifications fixes the constraints and conditions of quality, and for the production of the Soissons wheat. Because of the fact of the links in the system, this set of specifications, which is stored in the database of the baker, is distributed to the flour supplier from the baker. The four supplier may be referred to as a miller.

The computer apparatus of the miller has means for sending a message that the miller has received this set of specifications from the baker, and for integrating the specifications into the miller's own computer apparatus. Because the miller purchases the wheat from a supplier, he can, with the aid of his computer apparatus, create his own set of specifications, in particular specifying that the variety of wheat shall be Soissons. The supplier to the miller (who is, e.g., a granary operator) in turn will send a message that he has received said set of specifications from the miller. The granary operator or other supplier receives the conditions of quality and production of the Soissons variety of wheat. The granary operator or supplier may integrate said specifications into his database.

In turn, the supplier can, with the aid of his computer apparatus, create a set of specifications which fixes the conditions of quality and production of the Soissons wheat, said specifications to be sent to his agricultural source, a farmer.

The farmer, with the aid of his computer apparatus, sends a message to his client the supplier (granary operator), to indicate the farmer's acceptance of the set of specifications, and can integrate said specifications into the farmer's computer system.

From the moment when the farmer records the information on the Soissons variety of wheat, with the various corresponding parameters, in his agricultural file, if he subsequently delivers a variety of wheat which is not completely in accord with constraints established by his client, the supplier (e.g., granary operator) will be informed. For example, if the protein content is outside the acceptable range specified for the particular wheat, the supplier will immediately receive the information, and, by virtue of the various links established, the computer apparatus will indicate immediately to the supplier that the lot of wheat delivered by the farmer cannot be used for the baker who has imposed the set of specifications. If nonetheless certain lots of nonconforming wheat are delivered to the baker, the computer system, also by virtue of the fact of the links, allows to immediately determine, at the time of the declaration of delivery to the miller as well as at the time of the receipt of the lot by the baker, that this lot does not conform to the baker's set of specifications. The baker may reject or segregate the nonconforming lot or take other appropriate action.

In general, the invention enables an operator to determine that he satisfies the set of specifications, and enables the issuer of the set of specifications to verify that the specifications are being complied with by the operators, without the confidential information specific to each actor being accessible in an unauthorized fashion.

Thus, for the operators, the invention provides an effective means of assisting in distribution of their products. In practice, if a producer has a number of lots of products having different characteristics, he can quickly determine to which client each lot can be delivered. Thus, for example, a lot of wheat may be delivered to a baker or to an animal feed distributor, depending on its characteristics.

Further, the intervention of the server facilitates traceability, by interconnecting various actors, with the possibility of a hierarchy of access permissions.

According to a preferred embodiment of the invention, the server (or platform) comprises a database containing the identification and location of issuers of sets of specifications, and (the identification and location) of operators, the rights accorded to each issuer and each operator, and the relationships to be established between the actors, so as to enable an operator to have access to a set of specifications and to enable an issuer of said set of specifications to have access to the parameters furnished by the operator.

Preferably, the connection of the server to the issuers and the operators is accomplished by an intermediary of servers for indexing and routing.

The parameters of the operators may be entered manually, e.g. via a computer keyboard, or may be entered automatically with the aid of devices such as barcode readers, electronic label readers, or sensors.

This server can be readily utilized in a logistics chain, because it is adaptable to all existing configurations in the systems of production and distribution. In particular, a distributor can communicate a set of specifications for the components of a specific product. For example, suppose that a distributor of hamburger sandwiches has a set of specifications for the bread and a set of specifications for the meat, and possibly as well, a set of specifications for the packaging.

An operator may himself issue a set of specifications for his supplier(s). For example, the baker may issue a set of specifications to his flour supplier, and the flour supplier in turn may issue a set of specifications to wheat producers. It is also possible, with the aid of the server according to the invention, for the baker to issue a set of specifications to wheat producers, suppliers (granary operators), or millers.

According to another aspect of the invention, which may be utilized independently of the other aspects described supra, the invention relates to architecture of a service platform enabling one in simple fashion to link, preferably via the Internet, computer apparatuses of actors, in a logistics chain of manufacture or processing of products, particularly food products.

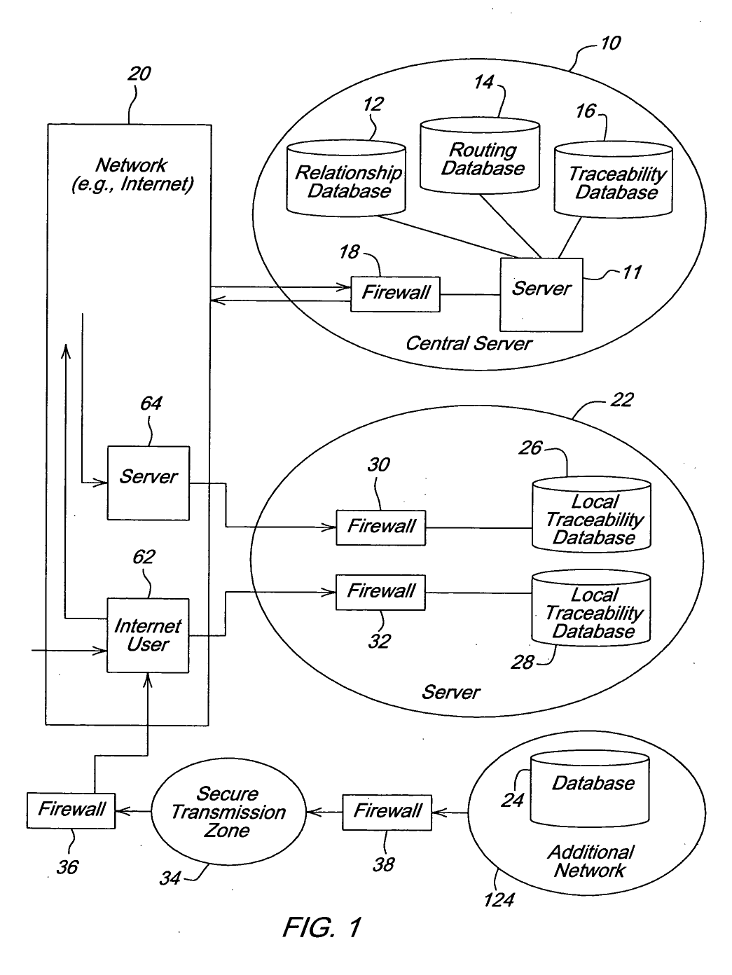

In accordance with FIG. 1, this service platform comprises: (a) a traceability database 16 intended to receive, from computer apparatus of each actor in the logistics chain, an identifier of an operation carried out, an identifier of the operator, information concerning the date the operation was carried out, and an identifier of the operation carried out immediately upstream of or downstream of the given actor; (b) a relationship database 12, recording (in memory) the rights of access of each actor, to information stored in the respective databases of the other actors; and (c) a routing database 14, providing the information needed for routing of the information between the actors, depending on data furnished by the traceability database and depending on the relationship database 12. The relationship database 12 may also be referred to as the right-of-access database.

Thus, the invention offers a highly simple architecture for establishing relationships between various actors in a logistics chain. This architecture, despite its simplicity, enables one to easily achieve traceability, while preserving the confidentiality of each actor's information.

In the case where this platform is used in combination with another aspect or other aspects of the invention, one provides, preferably, that the routing database contains the identification and location of methods of sets of specifications, and of operators who are users of said sets of specifications, wherewith the databases of the issuers of sets of specifications and the databases of the operators concerned are placed in interrelationship with the aid of data furnished by the said routing database and by the right-of-access database 12.

According to one embodiment, the platform is comprised of means of effecting links between data in a logistics chain, not only from the database of said platform but also from the traceability data stored under the auspices of (in the facilities of) at least certain actors (e.g., traceability database 26 and 28).

The invention also relates to an apparatus for acquisition of data and for consultation of data intended to be sent to the service platform defined above. This apparatus comprises means for, at the time of acquisition of data, transmitting automatically, to the traceability database 16 of a platform, an identifier of an operation carried out, an identifier of the operator, information concerning the date on which the operation was carried out, and an identifier of the operation carried out immediately upstream of or downstream of the actor who owns the equipment for data acquisition and data consultation.

According to one embodiment, the said computer apparatus is such as to enable one to issue and/or receive a set of specifications. A set of specifications consists of identifiers of operations or products (materials) to be used, or of parameters, or ranges of parameters. The apparatus in question, in this case, consists of means of verifying that the operations stored with the aid of this apparatus comply with the set of specifications.

According to one embodiment of such a disposition, the apparatus comprises means of sending an information signal, message, or alarm to the actors to which it is connected by the intermediary of the platform, in the event of nonconformity of the product or the processing to the set of specifications.

The invention also relates to a system comprising at least one platform, and further comprising a plurality of items of computer equipment, such as defined supra.

The system represented in FIG. 1, is intended to ensure quasi-automatic traceability of products or processes in a logistics chain, and to enable creation and management of specifications and conditions in such a logistics chain. The system of FIG. 1 comprises a server 10 for establishing links between partners or actors in a logistics chain.

This central server 10 comprises three databases, namely a relationship database 12 of relationships between partners, a routing database 14 of routing, and a traceability database 16 of traceability.

The relationship database 12 contains the inter-partner relationships, i.e. authorized links between actors in the logistics chain.

The routing data contained in routing database 14 comprise configuration information defining the path of each of the messages. This routing database 14 contains the routing and identification information for services of the partners. In particular, the routing database 14 contains the addresses of the servers of the partners on the Internet, the access parameters for these servers, and the services offered by each of the operators. For example, a request sent out by a baker who seeks access to the list of receipts of miller's wheat is received by server 10 and thus by the routing database, in the following form:

(a) type of originating operator equals identifier of a baker;

(b) originating operator equals identifier of baker X;

(c) service requested equals identifier of the service (list of receipts of miller's wheat);

(d) access parameters equals identifier for access, of the baker, and associated password.

In global fashion, the routing database 14 thus provides the relationships between the services and the operators offering the services, with the Internet address of each operator.

The traceability database 16 contains accurate data on traceability, establishing the links between documents created in the computer apparatuses of the actors in the chain.

The server 10 is linked, in a secure manner, e.g., via a firewall 18, to the network (e.g., Internet 20), so as to establish connections with the server 22 containing traceability data proprietary to certain actors, and connections with the database 24 of actors (e.g., traceability database 26 of a first actor and traceability database 28 of a second actor). The connection to the databases 12, 14, and 16 is accomplished via a server 11.

In this architecture, the server 22 is, e.g., managed similarly to the server 10, and contains, in secure manner, databases of traceability (26, 28), which are the property of particular actors. Each firewall (30, 32) protects the respective individual database.

To maximize the security of the data 24 of an enterprise, there is provided, between network 20 (e.g., Internet) and additional network 124, a secure transmission zone 34 with a firewall (36, 38) at each respective end.

The server 10 has the function of connecting the various databases (24, 26, 28) without these databases being accessible centrally. Thus, this architecture enables maximum security of access to the databases (e.g., through various firewalls), while providing the links needed to obtain, in real time, information relating to the quality and traceability of products.

The rights of access (i.e. the relationships between trading partners or actors) are determined by the actors themselves. The relationship or rights of access are introduced into the database 12 from the dedicated traceability server 22 of one or more actors.

In this example, the zone 34, the additional network 124, and the database 28 are allocated to or controlled by the same actor. An Internet server 62 is also allocated to said actor. Analogously, an Internet server 64 is allocated to the actor who owns or controls the database.

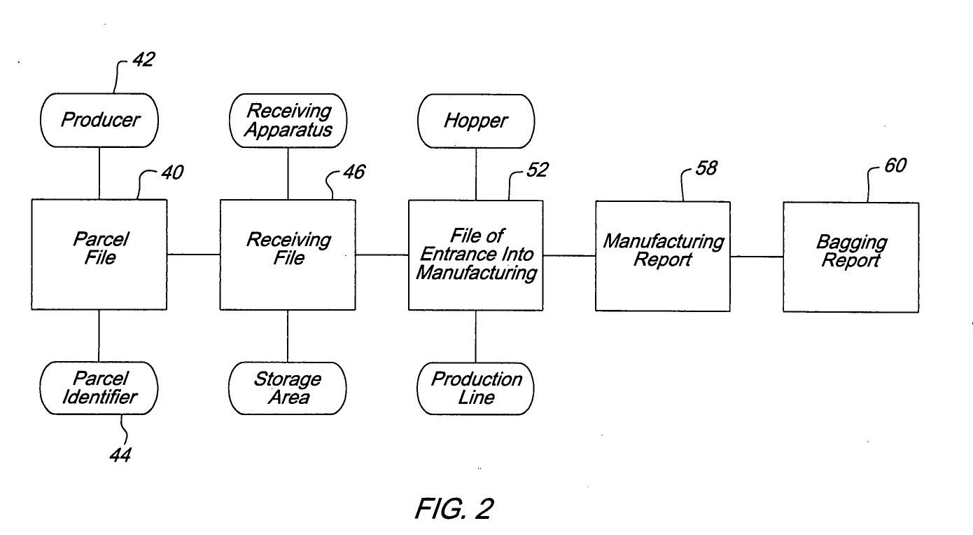

FIG. 2 represents an example of creation of documents in each computer apparatus of each actor. The documents enable the establishment, at the time of the data acquisition of each document, of traceability data stored in memory in the database 16.

In general, the equipment available to each actor comprises means of creating files for entry into memory, in the local database (e.g., traceability database 26 or 28), of:

(a) an identifier of the operation, and

(b) the date on which the operation was carried out.

This information is transmitted to the traceability database 16, to enable establishment of links between stored data.

Further, when the operation or process makes use of one or more products in the logistics chain, this information is also stored in memory and is automatically sent to the traceability database 16 to enable the database 16 to establish a link.

The example of FIG. 2 relates to the manufacture of potato chips, from the producer of the potatoes to the manufacturing plant.

In the logistics chain, the following documents are modeled for each actor.

The producer of the potatoes must fill out, with its computer equipment, a parcel file 40, which contains identification of the lots of potatoes, with reference to the producer 42, and a parcel identifier 44. The parcel identifier 44 identifies a parcel of land where a corresponding lot of potatoes was grown. Also, the file contains information relating to processing, such as dates of processing, pesticides used, seed plots (and/or seedlings) used, and harvesting dates.

When the lot of potatoes is delivered to the potato chip manufacturing plant, the lot references are introduced into a modeled document of the computer equipment of the receiving department of the manufacturing plant. This modeled document is referred to as the receiving file 46. The receiving file 46 comprises in particular a reference to the parcel file 40 and the date of receipt, as well as other information relating to analyses, stored in memory in the receiving database (e.g., dagtabase 26 or 28).

The information transmitted to the traceability database 16 comprises:

(a) the reference to the operation (referring to the nature of the operation, namely receiving); and

(b) the reference to the products delivered, including the assigned number of the parcel 44.

It is appreciated that in this way a traceability link is established via server 10, without server 10 being required to contain all the information relating to each operation.

Finally, when the potatoes enter into the manufacturing zone, a computer apparatus dedicated to this zone allows creation of a modeled document 52 comprising an entrance file 52 of entrance into manufacturing. The entrance file 52 comprises information about the operation being carried out, the date, and the origin of the potatoes (i.e. references to the receiving file 46), is stored. These data are also transmitted to the database 16.

Similarly, it is proposed to input information to a modeled document, comprising a manufacturing report 58. The manufacturing report 58 contains information on the operation carried out, the date of said operation, and the origin (with respect to the preceding operation, which here is the file of entrance file 52 of entrance into manufacturing).

Also proposed is a bagging report 60, issued directly from the manufacturing report 58. Because the manufacturing is automated, this document differs from the preceding report (manufacturing report 58) only in that it contains the bagging date and time, which may be, e.g., 45 minutes after the hour when manufacturing began.

When the product exits from the manufacturing, it is delivered to a distributor, who introduces it into his database, with the information relating to the delivery advice slip (i.e. the bagging report file 60 of the bagging report).

The distributor, using his equipment and his connection to the system indicated in FIG. 1, can obtain all the details of the logistics chain relating to the potato chips which have been delivered. The connections between the various modeled documents is established in the database 16, wherewith the rights of access into each of the databases are provided by the database 12, and the routing data of database 14 provide information so that each authorized actor can retrieve information for which he has the right of access, drawn from various databases in the manufacturing chain.

Thus, by virtue of the concatenation of the three types of information: (a) granted rights (inter-partner relations), (2) routing data, and (3) traceability data, the system represented in FIG. 1 provides all the information needed by each actor. In particular, the distributor of the potato chips can have access to various files (40, 46, 52, 58, 60) in the logistics chain. Through the information the distributor can determine, for example, the various processes, their parameters, the potatoes utilized, the dates relating to said potatoes, the analyses performed on the potatoes received at the manufacturing plant (information from document 46), or other information.

If, in this example, the distributor has imposed a set of conditions and specifications on each of the actors, or on certain of them, he can then verify that the specifications involved have been met. However, normally this verification will have been already performed prior to the delivery to the distributor, because each actor has, in his computer apparatus, means which deliver an alarm to him in an instance when the conditions and specifications have not been satisfied.

Having described the preferred embodiment, it will become apparent that various modifications can be made without departing from the scope of the invention as defined in the accompanying claims.

### Assignment

The entire right, title and interest in and to this application and all subject matter disclosed and/or claimed therein, including any and all divisions, continuations, reissues, etc., thereof are, effective as of the date of execution of this application, assigned, transferred, sold and set over by the applicant(s) named herein to Deere & Company, a Delaware corporation having offices at Moline, Ill. 61265, U.S.A., together with all rights to file, and to claim priorities in connection with, corresponding patent applications in any and all foreign countries in the name of Deere & Company or otherwise.

1. A platform for facilitating communication between or among actors in a logistics chain for manufacturing or processing of products, the service platform comprising:
a traceability database for receiving from at least one of a local traceability database and computer equipment of each actor in the logistics chain, an operation identifier of an operation carried out, an operator identifier of the operator, date information concerning the date the operation was carried out, and a context operation identifier of the operation carried out immediately upstream of or downstream of the given actor;
a relationship database for recording the rights of access of each actor, to information stored in the respective local databases of the other actors; and
a routing database, providing the information needed for routing of the information between the actors, depending on data furnished by the traceability database and the relationship database.

2. The platform according to claim 1 wherein the routing database further comprises issuer identification and issuer location of issuers of sets of specifications, and operator identifiers and operator location of operators who use these sets of specifications.

3. The platform according to claim 2 further comprising:
an issuer database of said issuers of the specifications;
operator databases of said operators using the specifications,
a server for placing in interrelation the issuer database, at least one of the operators and the operator databases with the aid of data furnished by the routing database, and by the relationship database.

4. The platform according to claim 2 further comprising:
linking establishment means for establishing links between data in the logistics chain, and for establishing links to traceability data stored under the auspices of or in facilities of at least certain actors.

5. The platform according to claim 2 further comprising:
acquisition equipment for acquiring data and transmitting the acquired data to the traceability database, the acquired data comprising the operation identifier, the operator identifier, the date information, and the context operation identifier of the operation carried out immediately upstream of or downstream of the data acquisition equipment.

6. The platform according to claim 2 further comprising a receiver for receiving a set of specifications comprising operation identifiers of operations and further comprising a verifier for verifying that the operation identifiers recorded satisfy said set of specifications.

7. The platform according to claim 6 wherein the specifications further comprise at least one of the products to be used, parameters for a corresponding product, and ranges of parameters for the corresponding product.

8. The platform according to claim 1 further comprising:
linking establishment means of establishing links between data in the logistics chain, and for establishing links to traceability data stored under the auspices of or in the facilities of at least certain actors.

9. The platform according to claim 1 further comprising:
acquisition equipment for acquiring data and transmitting the acquired data to the traceability database, the acquired data comprising the operation identifier, the operator identifier, the date information, and the context operation identifier of the operation carried out immediately upstream of or downstream of the data acquisition equipment.

10. The platform according to claim 1 characterized in that it comprises a sender for sending an information signal, message, or alarm to the actors to which it is connected by an intermediary of the platform, in the event of nonconformity of the product or the processing to the set of specifications.

11. The platform according to claim 1 wherein the local databases comprise traceability databases associated with corresponding actors and residing upon a common server, where each of the local traceability databases is protected from a communications via its respective firewall and supports transmission of the operation identifier, the date information, the operator identifier, and the operation context identifier to the traceability database.

12. The platform according to claim 1 wherein the traceability database further comprises at least one of a parcel file associated with a parcel of land associated with a particular lot of a raw product, a receiving file associated with receipt of the particular lot, a file of entrance into manufacturing associated with entrance of the raw product into a manufacturing process to product a finished product, a manufacturing report for the finished product, and a packaging report.

13. The platform according to claim 1 wherein the raw product comprises potatoes, the finished product comprises potato chips, and the packaging report comprises a bagging report.

14. The platform according to claim 1 wherein the raw product comprises a grain and the finished product comprises at least one of grain flour and food product.

15. A method for facilitating communication between or among actors in a logistics chain for manufacturing or processing of products, the method comprising:
receiving for entry into a central traceability database an operation identifier of an operation carried out, an operator identifier of the operator, date information concerning the date the operation was carried out, and a context operation identifier of the operation carried out immediately upstream of or downstream of the given actor;
recording in a relationship database the rights of access of each actor, to information stored in the respective local traceability databases of the other actors; and
routing of the information between the actors based on a routing database depending on data furnished by the central traceability database and the relationship database.

16. The method according to claim 15 wherein the routing database further comprises issuer identification and issuer location of issuers of sets of specifications, and operator identifiers and operator location of operators who use these sets of specifications.

17. The method according to claim 15 further comprising:
establishing links between data in the logistics chain and establishing links to traceability data stored under the auspices of or in the facilities of at least certain actors.

18. The method according to claim 15 further comprising:
acquiring data and transmitting the acquired data to the central traceability database, the acquired data comprising the operation identifier, the operator identifier, the date information, and the context operation identifier of the operation carried out immediately upstream of or downstream of the data acquisition equipment.

19. The method according to claim 15 further comprising:
receiving a set of specifications comprising operation identifiers of operations and further comprising a verifier for verifying that the operation identifiers recorded in memory to satisfy said set of specifications.

20. The method according to claim 19 wherein the specifications further comprise at least one of the products to be used, parameters for a corresponding product, and ranges of parameters for the corresponding product.

21. The method according to claim 19 further comprising:
sending an information signal, message, or alarm to the actors to which it is connected by an intermediary in the event of nonconformity of the product or the processing to the set of specifications.
